(19) United States
(12) Patent Application Publication
(10) Pub. No.: US 2010/0106304 A1
(43) Pub. Date: Apr. 29, 2010

(54) CONTROL DEVICE FOR A BLOWER AND AIR CONDITIONER MODULE FOR MOTOR VEHICLES

(76) Inventors: Juergen Alfred Wawer, Mechernich-Kommern (DE); Michael Weiss, Pulheim (DE); Andrea Gentile, Euskirchen (DE); Frank Schmitz, Bergisch Gladbach (DE)

Correspondence Address: FRASER CLEMENS MARTIN & MILLER LLC, 28366 KENSINGTON LANE, PERRYSBURG, OH, 43551, US

(21) Appl. No.: 12/605,669

(22) Filed: Oct. 26, 2009

(30) Foreign Application Priority Data
Oct. 29, 2008 (DE) 102008043300.4-16

(51) Int. Cl. G05B 15/00; F25D 17/06

(52) U.S. Cl. 700/275; 62/404

(57) ABSTRACT

A control device of a blower and air conditioner module a for motor vehicle is disclosed with a blower controller and an air conditioner controller, which governs the refrigerating plant with a refrigerant condenser, as well as flaps and valves of the blower and air conditioner module, and processes information from sensors and a man-machine interface, with the blower controller and the air conditioner controller, together with a blower motor controller of a blower motor designed as a central control device and it is placed on the blower motor.

### CROSS-REFERENCE TO RELATED APPLICATION

This application claims priority to German Patent Application No. DE 10 2008 043 300.4-16, filed Oct. 29, 2008, the entire disclosure of which is hereby incorporated herein by reference.

### FIELD OF THE INVENTION

The invention relates to a control device for a blower and air conditioner module for motor vehicles with a blower controller which governs the blower motor controller and the blower motor and with an air conditioner controller which governs the refrigerator with a refrigerant compressor of the blower and air conditioner module and processes information from sensors and a man-machine interface, and a controller which governs the flaps and the valves.

### BACKGROUND OF THE INVENTION

Control devices of the above-described class govern a blower and air conditioner module for motor vehicles. With it, all elements of the air conditioner are subject to the controller. This relates to generation of refrigeration as the heart component of the blower and air conditioner module, as well, however, as the blower with the electric motor and the flaps that are moved by actuators and, as additional important elements of the blower and air conditioner module, take care of regulating the transfer of cooled air from the module into the passenger compartment.

For this, each of these elements has an embedded control module, which is connected via a bus system with the pertinent control modules of the other elements of the blower and air conditioner module, a central control unit and the operator interface.

Generic control devices are known according to prior art.

DE 10 2005 035 451 B3 describes a single-strand or single-phase electronically commutated electric motor, especially a blower motor with a permanent magnetic rotor and a spooled stator with a single winding strand, as well as an electronic control circuit which feeds the winding strand in bipolar operation with an exciter current. The winding components are able to be governed separately from each other. In addition, the stator or rotor is configured with asymmetric poles, so that the two winding components generate their maximum torque at differing rotor positions. Thus, the invention produces a single-strange electric motor, which can reliably start from any rotor position into the pre-set direction of rotation without an increased reluctance moment. The invention-specific electric motor preferably comprises a control circuit that feeds the winding string with an excitation current and has a semiconductor bridge.

However, there is a disadvantage in that this controller is not configured for integration of additional functions, although a blower mostly is run in combination with other elements.

Additionally, in EP 0 288 658, a procedure is described for governing a motor vehicle air conditioner and the motor vehicle air conditioner for carrying out the procedure. The compressor performance, the condenser performance, and the vaporizer performance are detected directly or indirectly by sensors and passed as electrical values to the inlet terminals of a common electronic control circuit. While this occurs, the parameters for the demand for cooling performance, the vaporizer icing, the compression end temperatures and the fluid stroke are taken into account and appropriate output signals are generated.

These electrical output signals are passed to standardizing agents that can be electrically controlled for adjusting compressor performance, condenser performance, or vaporizer performance. With this, the process guidance of the overall facility is optimized. Thus, for example, the danger of so-called fluid stroke is avoided by measuring both the pressure and the temperature on the intake side of the compressor, and passing electrical signals corresponding to these values to the control circuit. Additionally, the rpm's of the vehicle's engine are measured by means of a sensor device and passed to the electronic control circuit. If it determines that the pre-set rpm's are being exceeded, by this means, rpm's that are damaging to the compressor can be avoided. Additionally, by means of a sensor, the position or movement of the gas pedal is detected and a corresponding signal is passed to the control circuit.

By this means it is possible to temporarily shut off the compressor, and, if necessary, the fan and blower drives in phases when the engine is in heavy acceleration phases, so that, for example, as much power as possible is available to the powered wheels of the vehicle during passing.

What is disadvantageous about EP 0 288 658 is that the complex controller is used solely for the cooling aggregate, and other aggregates that are part of the air conditioner, are not detected by this controller.

In DE 603 01 513 T2, a vehicle air conditioner control device is described that has an air conditioner cycle that uses an electrical cooling blower. This vehicle air conditioner control device has a compressor, a blower motor and a fan for cooling the blower. Additionally, the vehicle air conditioner device comprises a blower motor controller that governs the loading of the blower motor.

Additionally, various detectors are connected to the controller of the vehicle air conditioner. A vehicle status detector records vehicle data, with the control plan assessor measuring maximum effectiveness points in dependence on the detected vehicle data and determining the control plan in dependence on the measured results of the maximum effectiveness points.

What is disadvantageous with the solution as per this document is that no electronically commutable blower motor is provided, and that the controller of the blower motor does not govern additional functions of the air conditioner, especially tolerance-limited linear motions or pivoting motions.

U.S. Pat. No. 6,988,670 B2 describes an air conditioner for vehicles in which an integrated electronic module assumes the governance of various functions and receives signals from sensors. What is governed is the quantity of air that flows through the air conditioner and various flaps and mixers as well as actuators and servomotors.

The participating aggregates are to be governed via an integrated electronic module which includes one or more air temperature sensors of intake and exhaust air, temperatures of the compressor, and cooling water. Additionally, an actuator control switching circuit, a switching circuit for governing the speed of the blower motor, a switching circuit for governing the sensor, and a communication switching circuit for communication with the user interface are part of the integrated electronic module.

The disadvantage of this integrated electronic module is the continuing requirement to accommodate it at a specific location in a separate housing without using existing, already present controllers to add to the integrated electronic module. Additionally, the integrated electronic module does not have available any control devices integrated into it from electrically commutated motors.

Additional disadvantages and deficiencies are:
Compensation of tolerances: if multiple components are connected to a functional unit, within the framework of standardized tolerances of each individual element, for summing up of these tolerances, a value is reached that exceeds the limit of acceptability in an unfavorable case. This relates to both the electrical tolerances and the mechanical tolerances in moving parts.
Security and expense during signal transmission: if signals are transmitted, it must be ensured that interference influences do not alter the content of signals, or that they no longer are able to be understood by the receiving unit.
Space requirements: for each individual controller, connections are to be provided for the power supply and communication with the surroundings. Additionally, in each case, a housing is necessary.
Mutual influences of aggregates: when using differing aggregates that were not necessarily designed to work with each other, the result can be undesired mutual interactions and mutual influences to the detriment of the functionality of the overall controller.
Adjustments of the individual controllers to each other: when different controllers are used that were not necessarily designed to work with each other, the result can be adjustment problems and deficient functionality.

Therefore, the task that is the basis of the invention is to further develop a control device for a blower and air conditioner module for motor vehicles with a blower controller, a blower motor controller, and the blower motor and with an air conditioner controller which governs the refrigerating plant with a refrigerant compressor of the blower and air conditioner module, and processes information from sensors and a man-machine interface, a controller, which governs the flaps and valves, so that it is possible simply to adjust electrical tolerances of the assemblies and structural elements like sensors, motors and actuators, and mechanical tolerances in the motions of the individual elements, as well to implement it in a space-saving, low-interference and cost-effective way, avoid connecting individual control modules via a bus system, and embedding the individual control modules in already existing controls that are necessary and required. An additional task of the invention is to further develop a blower and air conditioner with a control device for motor vehicles, so that the disadvantages of decentralized controls for all the elements including the blower and air conditioner module in separate control devices are overcome.

### SUMMARY OF THE INVENTION

The problem is solved by a control device of a blower and air conditioner module for a motor vehicle with a blower controller which governs the blower motor controller and the blower motor and with an air conditioner controller, which governs the refrigeration unit with a refrigerant condenser of the blower and air conditioner module and processes information from sensors and a man-machine interface, and a controller which governs the flaps and valves, in which the blower controller and the air conditioner controller are embodied together with a blower motor controller of a blower motor as a central control device, and these are placed on the blower motor.

Additionally, the problem is solved by a control device in which the blower controller and the air conditioner controller, together with a condenser motor controller of an electric motor of a refrigerant condenser are embodied as a central control device and these are placed on the electric motor.

Also contributing to the solution is an electric motor which is embodied as an electronically commutated motor, and the central control device is embedded in the controller of the electric motor.

Aspects of the solution to the problem are the design of the central control device as an integrated circuit, the design of the central control device as a replaceable module, and additionally the design of the central control devices as a replaceable module.

One advantageous further development of the invention is the modular design of the central control device, with individual modules designed to be easily replaceable and able to be combined as per the functions to be attained.

In addition, one solution to the problem are the blower controller and the air conditioner controller, which, together with the blower motor controller of the blower motor, are designed as a central control device. This is placed on the blower motor.

With an additional aspect of the solution, the blower controller and the air conditioner controller, together with the condenser motor controller of the condenser motor of the refrigerant condenser are designed as a central control device, and this central control device is placed on the electric motor of the refrigerant condenser of the refrigerating plant.

In a further embodiment of the invention, the electric motor is designed as an electronically commutated motor, and the central control device is embedded into the controller of the electric motor.

The following advantages are connected with the invention-specific process:

the amount of space required by the central control unit is reduced in comparison with an individually designed controller

the central control unit is more fail-safe, because we are dealing with only one component

the central control unit requires less energy

the central control unit is more cost-effective, because the housing and interfaces are required only once, and in addition no external connections are required between the individual controllers

measures to increase the electromagnetic compatibility need be used only a single time

signals are transmitted with greater security in regard to signal transmission, interference, and malfunction safety, between the individual control models, because they are transmitted within the central control unit

a bus system with interfaces and connection cables between the previously separate modules is not required, and accordingly can be dispensed with at least in part

adjustment between the individual controllers within the central control unit can be optimized

compensation of electrical and mechanical tolerances of the overall blower and air conditioner module for motor vehicles can be programmed into the central control unit.

### BRIEF DESCRIPTION OF THE DRAWINGS

Additional particulars, features and advantages of the invention are derived from the following specification of an embodiment example with reference to the pertinent drawings. Shown are:

FIG. 1: Prior art.

FIG. 2: Central control device on the blower motor,

FIG. 3: Central control device on the refrigerant condenser.

FIG. 4: Perspective view of the blower and air conditioner module.

FIG. 5: Modular control device.

### DETAILED DESCRIPTION OF EXEMPLARY EMBODIMENTS OF THE INVENTION

The following detailed description and appended drawings describe and illustrate various embodiments of the invention. The description and drawings serve to enable one skilled in the art to make and use the invention, and are not intended to limit the scope of the invention in any manner. In respect of the methods disclosed, the steps presented are exemplary in nature, and thus, the order of the steps is not necessary or critical.

FIG. 1 shows the prior art. The depicted blower and air conditioner module 1 comprises in its interior the refrigerating plant 6 with a refrigerant condenser 15, electric motor 16 and condenser motor controller 14, the blower controller 4, the air conditioner controller 3 and the blower motor 7, which is equipped with the blower motor controller 8.

The three controllers are connected as separate components with each other, with air conditioner controller 3 and blower controller 4 already combined in such a way that they are accommodated in a common housing.

The air conditioner controller 3 is supplied by sensors 9 and 10 with information, with sensor 9 being an internal sensor and sensor 10 being an external sensor. The blower controller 4 has sensors 11 and 12, with sensor 11 being an internal sensor and sensor 12 being an external sensor. Also attached to blower controller 4 are the flaps and valves with the pertinent actuators 13. Man-machine interface 2 serves as the user interface, which supplies both air conditioner controller 3 and blower controller 4 with the appropriate operating commands of the operator.

Controller 17 governs the actuators 13 for flaps and valves, and for this purpose is connected directly with controllers 3, 4 as well as indirectly with controllers 8 and 14 in functional fashion.

Thus, with the prior art, all three control modules are designed to be separate, with no component-level connection or functional integration.

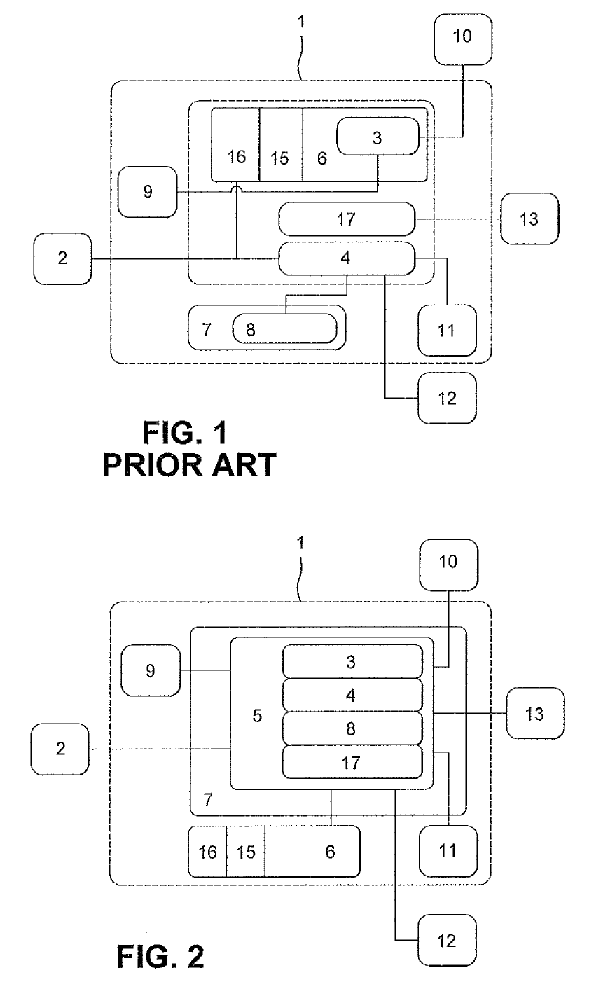

FIG. 2 shows the blower and air conditioner module 1, the blower motor 7, the refrigerating plant 6 with refrigerant condenser 15 and the electric motor 16, as well as the central control device 5. This is attached to the blower motor 7. Embedded into the central control device 5 and connected with it are the air conditioner controller 3, blower controller 4, the controller 8 of blower motor 7 and the controller 17 of the flaps and valves 13.

The input signals required for operation are received by central control device 5 from man-machine interface 2 as well as sensors 9, 10, 11, 12, with sensors 10 and 12 being external sensors and sensors 9 and 11 being internal sensors. Internal sensors 9, 11 obtain operational data of the blower and air conditioner module 1. These are primarily temperature, pressure, and rpm values as well as electrical parameters. External sensors 10, 12 are accommodated at various locations in the vehicle and transmit data from there. Primarily, these are temperature values. Additionally, sensors are used which analyze insolation and comfort values like moisture and air quality, here not separately depicted, but these likewise are used as external sensors.

Also connected with the central control device 5 are the flaps and valves with actuators 13; their controller 17 is likewise embedded into central control device 5. The refrigerating plant 6 with refrigerant condenser 15, which is driven by electric motor 16, has the condenser motor controller 14, from which it receives the control signals required for operation. The condenser motor controller 14 is embedded into the central controller 5. With this, only a single control device, namely central control device 5, is needed, which assumes all the governing tasks that previously were designed in decentralized fashion. Also, the number of interfaces and connections between the individual control devices 3, 4, 8, 14, 17 is reduced, because they now are centrally concentrated into central control device 5. With this, an external connection is obviated between each other via interfaces and a bus system.

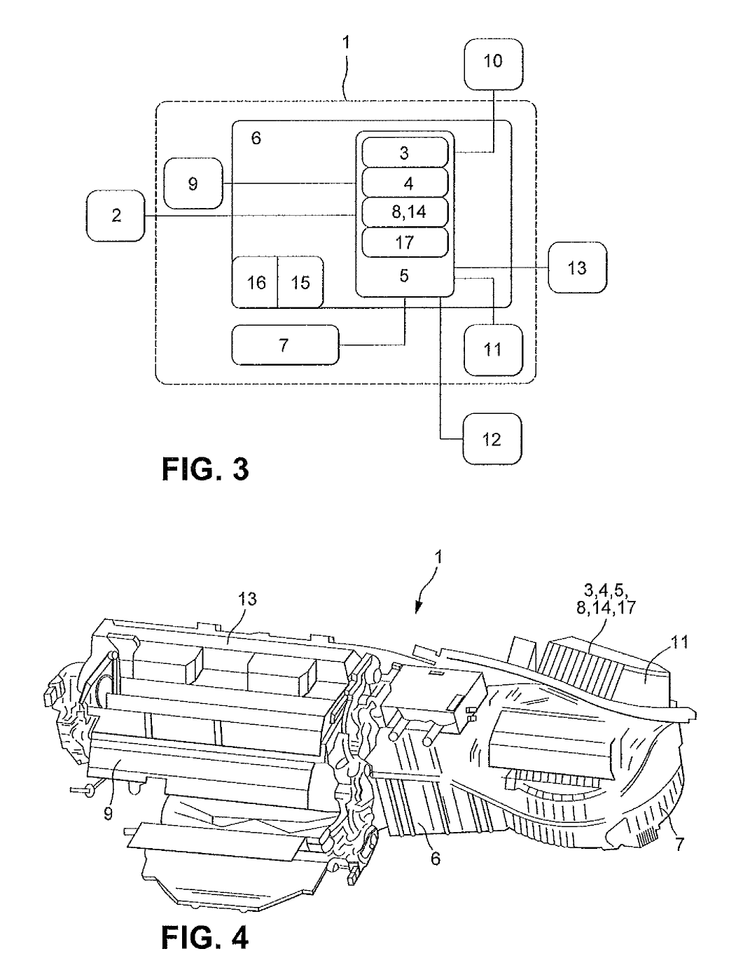

FIG. 3 shows another embodiment example of central control device 5 on the refrigerating plant, in particular on the electric motor 16 of refrigerant condenser 15, as it is implemented in this embodiment form as an alternative to embedding in blower motor 7.

Here also, air conditioner controller 3, blower controller 4 and blower motor controller 8 of blower motor 7, condenser motor controller 14 and the controller of the actuators for flaps and valves 17, are combined into central control device 5. It is connected with refrigerating plant 6 with refrigerant condenser 15 into one structural unit and embedded in electric motor 16. Also governed by central control device 5 are the blower motor 7 and the flaps and valves with actuators 13, since their controller 17 is likewise embedded into central controller 5. Input signals which central control device 5 processes, come from man-machine interface 2 as well as sensors 9, 10, 11, 12. In the embodiment shown, blower motor 7 is designed as an electronically commutated motor, to govern which the blower motor controller 8 serves which is embedded into central control device 5.

Refrigerating plant 6 with refrigerant condenser 15 has an electric motor 16 available, which is implemented in the depicted embodiment form as an electronically commutated motor. In its specific functions, it is governed as an electronically commutated motor by condenser motor controller 14.

FIG. 4 shows an embodiment of the blower and air conditioner module for motor vehicles 1 in a perspective view.

Its basis is central control device 5, and connected with it into a structural unit, the air conditioner controller 3 integrated into it, the blower controller 4 and the controller of blower motor 8. This assembly is combined in such a way and manner that it has available only a single housing as well as common attachments and interfaces to its surroundings. These supply energy and transmit signals. The internal sensors 9 and 11 pass signals to central control device 5, which processes these signals. In like manner, the signals of the sensors not shown which are distributed in the vehicle are processed, which are known from the description of the other embodiment examples and provided there with reference numbers 10 and 12. The man-machine interface also influences the function through external governing signals.

Some of the flaps and valves with actuators 13 are integrated in the blower and air conditioner module 1 and depicted in the figure, but some of them are also installed in decentralized fashion in the vehicle and thus, do not appear in the figure. There they provide for the distribution of the air cooled in the blower and air conditioner module 1 with the goal of creating the desired conditions in the passenger compartment. However, they are delivered with the blower and air conditioner module 1, and are adjusted together with the other components and central control device 5 in such a way that tolerances appearing in both the electrical and the mechanical area are allowed for, and compensated for by sensible control measures.

Additionally depicted are the refrigerating plant with refrigerant condenser 6, as well as the blower motor 7 on the right side of the blower and air conditioner module. In the embodiment example, central control device 5 is implemented as an integrated circuit, wherewith the miniaturization and the advantages connected therewith come to bear. Counted in this in particular are the space and energy requirements, low costs, and also optimal adjustment of components to each other as well as flexibility in programming the functions.

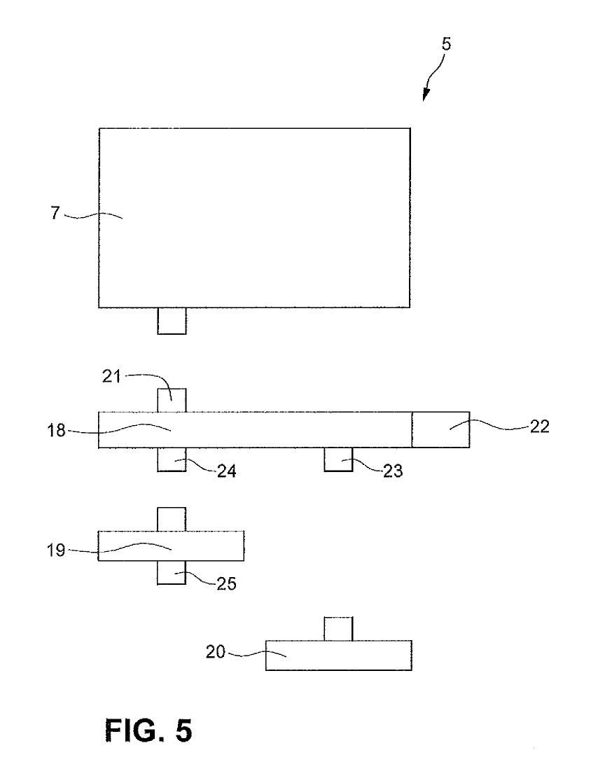

FIG. 5 shows an advantageous embodiment in which central control device 5 is attached onto blower motor 7 in such a way that it is easy to remove, and thus, is able to be exchanged for another complete module, designed as the motherboard 18 of central control device 5. This can occur when there is a defect in the course of the repair, but also for installation of a new controller with altered functions. This occurs advantageously through a plug connection, plug 21, that secures against undesired loosening, which can be unplugged without the use of tools. The motherboard module 18 of central control device 5 is removed and replaced by another.

In a further advantageous embodiment of the invention, the individual components of central control device 5 are implemented as separate modules, expansion boards A and B with reference numbers 19 and 20. This relates to air conditioner controller 3, blower controller 4, and controllers 8 and 17, which are both configured as a module that is easily replaceable as expansion boards 19, 20, advantageously implemented as secured plug connection 23, 24.

Also, a combination of more than one of the control devices 3, 4, 8, 14 and 17 in one module is the part of the embodiment of the invention. Through this measure, the modules are replaceable as motherboards or expansion boards 18, 19, 20 of controllers 3, 4, 8 and 17 individually or in groups. This purpose is also served by the HMI vehicle plug 22 and the plug for the components 25. Thus, specific functions of central controller 5 can be altered in totality and are able to be replaced individually or in groups if there is a defect. Additionally, the central control device 5 can be modified in detail in its complex functionality, without needing to replace the entire assembly.

Instead of the blower motor 7 depicted in the embodiment example, another electric motor can also be supplemented by the control device 5 with a modular design.

From the foregoing description, one ordinarily skilled in the art can easily ascertain the essential characteristics of this invention and, without departing from the spirit and scope thereof, make various changes and modifications to the invention to adapt it to various usages and conditions.

### LIST OF REFERENCE SYMBOLS

1 Blower and air conditioner module
2 man-machine interface
3 air conditioner controller
4 blower controller
5 central control device
6 refrigerating plant with refrigerant condenser
7 blower motor
8 blower motor controller
9 internal sensors of refrigerant condenser
10 external sensors of refrigerant condenser
11 internal sensors of blower
12 external sensors of blower
13 flaps and valves with actuators
14 condenser motor controller
15 refrigerant condenser
16 electric motor of refrigerant condenser
17 controller of actuators for flaps and valves
18 motherboard
19 expansion board A
20 expansion board B
21 plug for electric motor
22 HMI vehicle plug
23 plug for expansion board A
24 plug for expansion board B
25 plug for components

What is claimed is:

1. A control device of a blower and air conditioner module for a motor vehicle comprising:
a blower controller which controls a blower motor;
an air conditioner controller which controls a refrigerating plant including a refrigerant condenser, wherein the air conditioner controller processes information received from at least one sensor and a man-machine interface;
an actuator controller which controls actuators of at least one of a flap and a valve of a blower and air conditioner module; and
a central control device disposed on the blower motor, wherein the blower controller, the air conditioner controller, and the actuator controller are integrated into the central control device.

2. The control device according to claim 1, wherein the blower controller includes a blower motor controller and the blower motor controller is integrated into the central control device.

3. The control device according to claim 2, wherein the blower motor is an electronically commutated motor and the central control device is embedded in the blower motor controller.

4. The control device according to claim 1, wherein the central control device is an integrated circuit.

5. The control device according to claim 1, wherein the central control device is a replaceable module.

6. The control device according to claim 1, wherein the central control device is modular and individual modules are replaceable and able to be combined corresponding to a function to be achieved.

7. A control device of a blower and air conditioner module for a motor vehicle comprising:
a blower controller which controls a blower motor;
an air conditioner controller which controls a refrigerating plant including a refrigerant condenser and at least one of a flap and a valve of a blower and air conditioner module, and wherein the air conditioner controller processes information from at least one sensor and a man-machine interface;
a condenser motor controller which controls a condenser motor of a refrigerant condenser; and
a central control device disposed on the condenser motor, wherein the blower controller, the air conditioner controller, and the condenser motor controller are integrated into the central control device.

8. The control device according to claim 7, wherein the condenser motor is an electronically commutated motor and the central control device is embedded in the condenser motor controller.

9. The control device according to claim 7, wherein the central control device is an integrated circuit.

10. The control device according to claim 7, wherein the central control device is a replaceable module.

11. The control device according to claim 7, wherein the central control device is modular and individual modules are replaceable and able to be combined corresponding to a function to be achieved.

12. A control device of a blower and air conditioner module for a motor vehicle comprising:
a blower controller which controls a blower motor, wherein the blower controller includes a blower motor controller;
an air conditioner controller which controls a refrigerating plant including a refrigerant condenser, wherein the air conditioner controller processes information received from at least one sensor and a man-machine interface;
a condenser motor controller which controls a condenser motor of a refrigerant condenser; and
a central control device disposed on one of the condenser motor and the blower motor, wherein at least two of the blower controller, the blower motor controller, the air conditioner controller, and the condenser motor controller are integrated into the central control device.

13. The control device according to claim 12, wherein the central control device is disposed on the condenser motor and the condenser motor is an electronically commutated motor, and wherein the central control device is embedded in the condenser motor controller.

14. The control device according to claim 12, wherein the central control device is disposed on the blower motor and the blower motor is an electronically commutated motor, and wherein the central control device is embedded in the blower motor controller.

15. The control device according to claim 12, wherein the central control device is an integrated circuit.

16. The control device according to claim 12, wherein the central control device is a replaceable module.

17. The control device according to claim 12, wherein the central control device is modular and individual modules are replaceable and able to be combined corresponding to a function to be achieved.
